(19) United States
(12) Patent Application Publication
(10) Pub. No.: US 2008/0266664 A1
(43) Pub. Date: Oct. 30, 2008

(54) Liquid light pipe with an aplanatic imaging system and coupled non-imaging light concentrator

(76) Inventors: Roland Winston, Merced, CA (US); Alexander Ritschel, Merced, CA (US)

Correspondence Address: Roland Winston, 3384 Locksley Court, Merced, CA, 95340, US

(21) Appl. No.: 11/789,496

(22) Filed: Apr. 24, 2007

(51) Int. Cl. F21V 8/00; F21V 33/00

(52) U.S. Cl. 359/592; 359/591

(57) ABSTRACT

An optical system for a solar lighting device to provide highly concentrated sunlight to interior spaces with minimal disruption of building envelope. The optical system includes an aplanatic optical imaging system mounted on a dual-axis sun tracker, a non-imaging solar concentrator coupled to the aplanatic system, a liquid light pipe to convey the very intense solar flux to the interior of a building, a diffusing light fixture to spread the daylight into the interior space, and a control system to regulate the light output to a constant and desired level.

The present invention is concerned with solar daylighting employing an optical system which provides extremely high solar flux to produce very efficient light output. More particularly, the invention is directed to a solar energy system which combines a non-imaging light concentrator, or angle transformer, with an aplanatic primary and secondary mirror subsystem wherein the non-imaging concentrator is efficiently coupled to the mirrors such that imaging conditions are achieved for high intensity light concentration onto a light pipe.

### BACKGROUND OF THE INVENTION

Daylighting systems are very well known in the form of sky lights which are low cost but can only be used in the top floor of buildings and have the disadvantage of requiring large roof penetrations which lead to undesirable heat loss in winter and heat gain in summer and are prone to rain water infiltration. Daylighting systems employing fiber optics which do not require large roof penetrations and can be used in all floors of a building have been developed, but are not in wide use due to the high cost of optical fiber and the use of large, cumbersome optical systems. In order to even compete with sky lights or other daylighting systems, the compactness and economics must be drastically improved.

One example of prior art of concentrating daylighting is the Hybrid Solar Lighting technology developed by Oak Ridge National Laboratory and commercialized by Sunlight Direct, LLC. It uses a solar concentrator to collect and distribute sunlight into the interior of a building via plastic optical fibers. According to the US Department of Energy, Office of Energy Efficiency and Renewable Energy, this system is the most recent technology: “The most recent technology, hybrid solar lighting, collects sunlight and routs it through optical fibers into buildings where it is combined with electric light in ‘hybrid’ light fixtures. Sensors keep the room at a steady lighting level by adjusting the electric lights based on the sunlight available. This new generation of solar lighting combines both electric and solar power. Hybrid solar lighting pipes sunlight directly to the light fixture and no energy conversions are necessary, therefore the process is much more efficient. It is currently being developed and tested by Oak Ridge National Laboratory in collaboration with the Department of Energy and several industry partners.”

Another example of prior art is a system from Parans Daylight AB in Gothenburg, Sweden employing Fresnel lenses and fiber optics. A similar system was also developed at the University of Nottingham in the United Kingdom.

Another example of prior art is the “Himawari” system of La Foret Engineering Co., Ltd. in Tokyo, Japan. The system employs Fresnel lenses and large diameter quartz glass fibers.

### SUMMARY OF THE INVENTION

Aplanatic optical imaging designs are combined with a liquid light pipe and optionally a non-imaging optical system for numerical aperture (NA) matching to produce an ultra-compact light concentrator that performs near the etendue limits. In a solar daylighting system the aplanatic optics along with a coupled liquid light pipe and optionally a non-imaging concentrator angle transformer for NA matching produce light output with very high efficiency.

A variety of aplanatic and planar optical systems can provide the necessary components to deliver light to a liquid light pipe, which forms a highly concentrated light output to an interior space. In one embodiment a secondary mirror is co-planar with the entrance aperture, and the location of the focal plane is chosen to accommodate the NA of the liquid light pipe. Alternatively, a nonimaging light concentrator may be introduced to the optical system to transform the NA of the two mirror system to the NA of the liquid light pipe. The non-imaging light concentrator is disposed at the focal plane of the two mirror system wherein the non-imaging concentrator is a θ₁/θ₂ angular transformer with θ₁ chosen to match the NA of the two mirror system (sin θ₁=NA₁) while θ₂ is chosen to match the NA of the liquid light pipe (sin θ₂=NA₂). Also, θ₂ is chosen to satisfy a subsidiary condition, such as maintaining total internal reflection (“TIR”). In most cases these two conditions are compatible.

It is readily shown on general grounds that for the most compact imaging system with a primary and secondary mirror the ratio of depth to diameter is 1:4. FIG. 1 exemplifies this relation. In a preferred embodiment, such as depicted in FIG. 1, the NA of the aplanatic imaging system matches the NA of the liquid light pipe obviating the need for a nonimaging angle transformer.

This system with its combination of elements enables employment of the highly efficient and low cost liquid light pipe such that a very intense solar flux can be conveyed to an interior space. With concentrated solar flux of 300-500 times ambient insolation, the roof penetration required for the same light output is reduced in area by the same factor. The system described herein can provide highly concentrated sunlight to interior spaces with minimal disruption of building envelope. This feature combined with the low cost high efficiency liquid light pipe makes this system very attractive commercially. The optical system therefore provides the light intensity needed to achieve commercial effectiveness for solar day lighting. Moreover, the concentrating daylighting system can be integrated into buildings in an esthetically pleasing and minimally intrusive way. This feature makes the system attractive for retrofitting of existing buildings, which is problematic for prior art daylighting systems. Another benefit of the concentrating daylighting system is that the liquid light pipe can be easily integrated into conventional light fixtures producing daylight illumination without the glare that is a frequent problem of standard daylighting systems. Moreover, augmentation with electric light is desirable because of the variability of daylight. In our system this is easily achievable by adding complementary electric light sources into the same light fixture. This facilitates control of the overall illumination.

Objectives and advantages of the invention will become apparent from the following detailed description and drawings described hereinbelow.

### BRIEF DESCRIPTION OF THE DRAWINGS

FIG. 1 illustrates an aplanatic optical system coupled to a liquid light pipe.

FIG. 2 illustrates an aplanatic optical system coupled to a nonimaging angle transformer which, in turn is coupled to a liquid light pipe; and

FIG. 3 illustrates an aplanatic optical system coupled to a liquid light pipe which in the interior space is coupled to a light diffuser or luminaire.

### DETAILED DESCRIPTION OF THE PREFERRED EMBODIMENTS

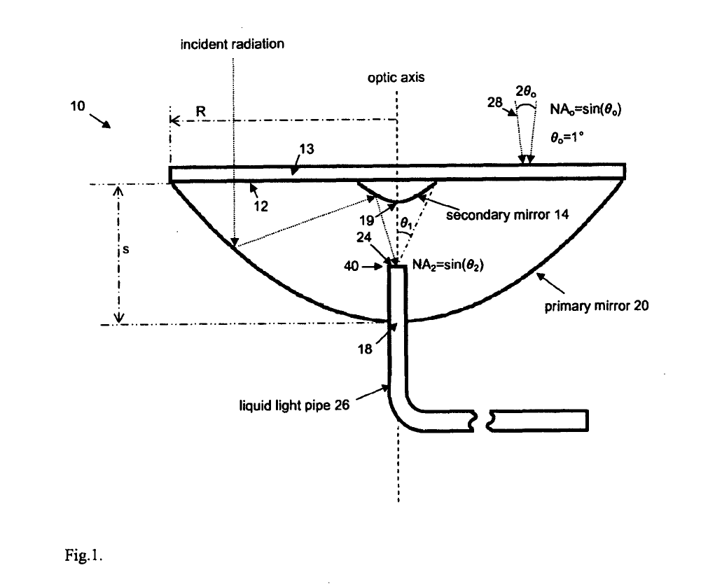

An optical system 10 constructed in accordance with one embodiment of the invention is shown in FIG. 1. A primary mirror 20 and a secondary mirror 14 comprise a two mirror system. The secondary mirror 14 is co-planar with the entrance aperture 12 of the primary mirror 20. A protective window 13 covers the entrance aperture 12 and supports the secondary mirror 14. The focal plane of the two mirror system resides at a location 40 intermediate between the vertex 18 of the primary mirror 20 and the vertex 19 of the secondary mirror 14 such that the angle 20, subtended by the secondary mirror accommodates the NA of the liquid light pipe 26, which is equal to sin(θ₂). Solar radiation incident over angle 2θ₁ (the convolution of the solar disk with optical errors) is concentrated to the focal plane 40 where it is distributed over angle 2θ₁.

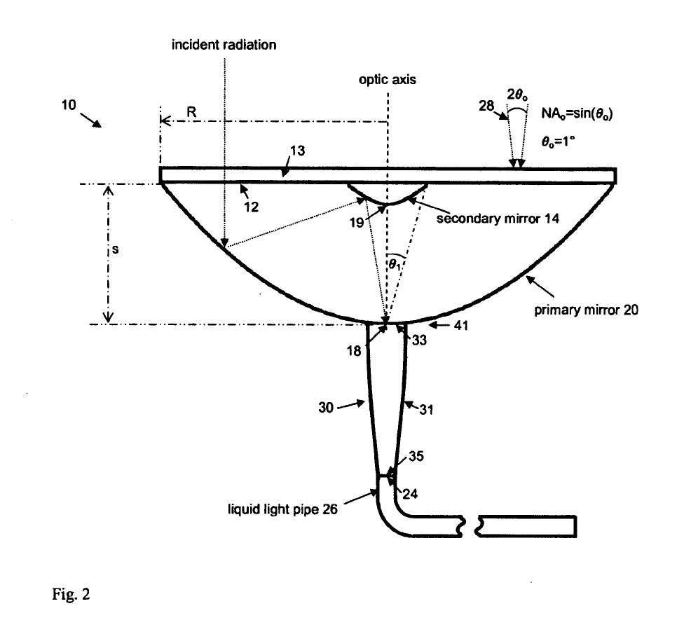

In an alternative embodiment, as shown in FIG. 2, a non-imaging concentrator 30 is disposed at the focal plane 41 of the two mirror system, which is located near the vertex 18 of the primary mirror 20. This concentrator 30 is most preferably θ₁/θ₂ angular transformer with θ₁, chosen to match the NA of the two mirror system (sin θ₁=NA₁) while θ₂ is chosen match the NA of the liquid light pipe (sin θ₂=NA₂). θ₂ is also chosen to satisfy a subsidiary condition, such as maintaining total internal reflection (“TIR”). In most cases these two conditions are compatible. The concentration or flux boost of the terminal stage approaches the fundamental limit of (sin θ₂/sin θ₁)². The overall concentration can approach the etendue limit of (sin θ₂/sin θ₀)². Alternatively, the non-imaging concentrator 30 can be a known tailored non-imaging concentrator.

In the angle transformer 30, both the entrance aperture 33 and the exit aperture 35 are substantially flat, making this a straightforward case to analyze. In fact, the preferred angle transformer 30 has a design which falls under the category of well-known θ₁/θ₂ non-imaging concentrators. The condition for TIR is

θ₁+θ₂≦π=2θ_{c} (1)

where θ_{c} is the critical angle, arc sin (1/n). n is the index of refraction of the angle transformer 30 and is typically about 1.5.

In many cases of practical importance the TIR condition is compatible with limiting the exit angle θ₂ to reasonable prescribed values. Since the overall optical system 10 is near ideal, the overall NA is NA₂=sin (θ₂). NA₂ is chosen to match the NA of the liquid light pipe 26. In an alternative embodiment a reflective surface 31 of the concentrator 30 need not be such that TIR occurs. In this case the exterior of the θ₁/θ₂ concentrator 31 can be a silvered surface incurring an optical loss of approximately one additional reflection (˜4%). The coupling between the exit aperture 35 of the angle transformer 30 and the entrance window 24 of the liquid light pipe 26 is preferably index matched, however, a small air gap, which introduces about 10% Fresnel reflection losses, is tolerable.

The overall optical system 10 is near-ideal in that raytraces of both imaging and nonimaging forms of the concentrator 30 reveal that skew ray rejection does not exceed a few %. Co-planar designs can reach the minimum aspect ratio (f-number) of ¼ for the two mirror system that satisfies Fermat's principle of constant optical path length.

The performance of the two mirror system is not affected by chromatic aberration typical of lens systems. All dielectrics that are transparent in some wavelength range will have dispersion, a consequence of absorption outside the transparent window. Even for glass or acrylic, where the dispersion is only a few percent, this significantly limits the solar flux concentration achievable by a well-designed Fresnel lens. For a planar form of the two mirror system, the only relevant refracting interfaces are the two surfaces of the window 13, normal to an incident beam 28. At the interface (the entrance aperture 12) angular dispersion is,

δθ=−tan(θ)δn/n (2)

which is completely negligible since the angular spread of the incident beam 28 is <<1 radian. The optical system 10 is for practical purposes achromatic. In fact, Equation (2) indicates some flexibility in design. The dielectric/air interface (the entrance aperture 12) need not be strictly normal to the beam. A modest inclination is allowable, just as long as chromatic effects, as determined by Equation (2) are kept in reasonable bounds.

While the light pipe is a very effective flux homogenizer, it may be useful to homogenize the input flux to mitigate hot spots. The aplanat is an imaging design, imaging the sun and causing hot spots at the exit of approximately (sin(θ₀/sin(θ₅))² where θ₀ is the angular acceptance of the system and θₛ is the semi-angle of the solar disc which is approximately ¼ degree. For materials reasons, because thermal and/or flux excursions are potentially problematic for long term operation, this may be undesirable.

A variety of Kohler homogenizer and planar optical systems formed by two mirrors can provide the necessary components to deliver light to a light pipe or nonimaging concentrator. In the Kohler homogenizer, radial symmetric mirror segments on both primary and secondary mirrors are pair-wise correlated so that the segment on the primary images the field of view onto the secondary segment, while the secondary segment in turn, images the primary segment on the target. Alternatively, the Kohler homogenization can be done in both the radial and saggital directions so that the mirror segments in both primary and secondary are disposed in either in a rectangular or hexagonal pattern. This embodiment is sometimes referred to as a “free form” design. In one embodiment a secondary mirror is co-planar with the entrance aperture, and the exit aperture is co-planar with the vertex of the primary mirror.

For illumination of interior spaces it may be beneficial to tailor the spectrum. Removing the infra-red component mitigates heating the interior space. Removing the ultra-violet component is beneficial to avoid damage to materials. The use of reflective optics facilitates this function. In particular, the small secondary mirror may have a multi layer coating to achieve this result.

Liquid light pipes are a relatively new technology that offers an attractive alternative to fiber optics. They are much less costly, replacing expensive fiber with inexpensive liquid and they are efficient. There is no loss of efficiency due to the packing loss typical of fiber bundles, and the liquid medium has low attenuation and very low cost. They are an ideal complement to the compact optical system that characterizes this invention.

The following non-limiting examples are merely illustrative of the design of the system.

### EXAMPLE 1

Primary mirror 20 combined with secondary mirror 14 are elements of an aplanatic design of maximum compactness where 2R/s ≈4, as shown in FIG. 1. The liquid light pipe 26 is positioned with entrance aperture 24 at the focal plane 40 of the two mirror system. The focal plane location 40 is chosen to match the NA of the liquid light pipe, for which 0.42 is a typical value. A transparent cover 13 encases the optics providing protection against the elements. The unit is mounted on a dual axis sun tracker with sufficient angular accuracy to accommodate 28 the angular acceptance (θ₀≈1 degree) of the optical system. Notice that sin θ₀ ≈NA₂/(C)^{1/2} where C is the geometrical concentration as befitting an etendue limited system.

### EXAMPLE 2

In another embodiment, which is depicted in FIG. 2, the focal plane of the two mirror system 41 is placed at the vertex 18 of the primary mirror 20 so that the NA₁=sin θ₁≈0.25. To accommodate the liquid light pipe NA₂=0.42 a non-imaging optical concentrator (or angle transformer) 30 is used with θ₁=15 degrees, θ₂=25 degrees. The nonimaging optical element can operate by total internal reflection.

### EXAMPLE 3

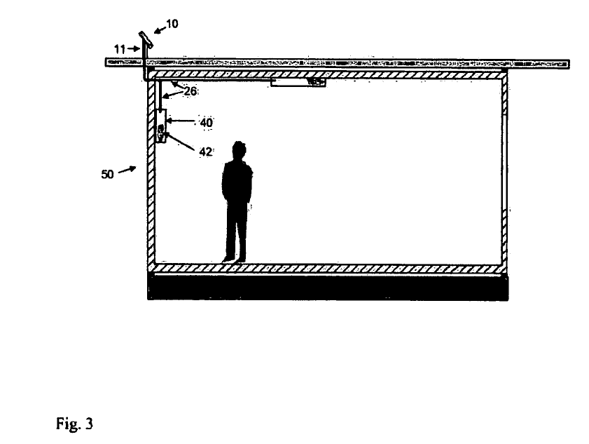

As shown in FIG. 3, the optical system 10, which is mounted on a dual-axis sun tracker 11 that is positioned on the roof of a building 50, concentrates sunlight into the liquid light pipe 26, which conveys the concentrated sunlight through a small roof penetration or an existing duct to a diff-using light fixture 40 that can be mounted on the ceiling or a wall of the room. The concentrated sunlight can be augmented by an electric light source 42 that can be integrated into the diffusing light fixture 40. The light emittance from the diffusing light fixture can be controlled to a constant value with a lighting control system that regulates the light emittance from the electric light source in response to the available sunlight or to the total light output of both the concentrating daylighting and the complementary electric light system.

What is claimed is:

1. A system for collecting and conveying light for illumination of a space, comprising:
a solar collector;
a liquid light pipe coupled to the solar collector; and
an output component for dispersing light received from the liquid light pipe.

2. The system as defined in claim 1 further including a dual axis sun tracker for input of light into the liquid light pipe.

3. The system as defined in claim 1 further including a diffuser coupled to the output component to spread the light into the space.

4. The system as defined in claim 1 further including a control component to regulate output of the light into the space.

5. The system as defined in claim 1 wherein the solar collector includes a primary and secondary mirror subsystem.

6. The system as defined in claim 5 wherein the primary and secondary mirror subsystem comprises aplanatic optics.

7. The system as defined in claim 5 further including a non-imaging light concentrator to match the numerical aperture to the primary and secondary mirror subsystem.

8. The system as defined in claim 5 wherein the secondary mirror subsystem is substantially coplanar with an entrance aperture of the subsystem.

9. The system as defined in claim 8 wherein a focal plane of the subsystem is chosen to accommodate the numerical aperture of the light pipe.

10. The system as defined in claim 9 wherein the location of the focal plane is chosen to accommodate the numerical aperture of the light pipe.

11. The system as defined in claim 5 further including a non-imaging light concentrator for transforming the numerical aperture of the subsystem to the numerical aperture of the liquid light pipe, thereby allowing the light pipe to be disposed at a selected structurally convenient location.

12. A system for collecting and conveying light for illumination of a space, comprising:
a solar collector;
a non-imaging light concentrator coupled to the solar collector;
a liquid light pipe coupled to the solar collector; and
an output component for dispersing light received from the liquid light pipe.

13. The system as defined in claim 12 further including a primary and secondary mirror subsystem wherein the non-imaging light concentrator is disposed in the system to transform the numerical aperture of the subsystem, thereby allowing the light pipe to be disposed at a structurally convenient plane.

14. The system as defined in claim 13 wherein the non-imaging light concentrator has a θ₁/θ₂ angle transformer with θ₁ selected to match the numerical aperture of mirrors of the subsystem.

15. The system as defined in claim 14 wherein θ₂ is selected to maintain total internal reflection by the non-imaging light concentrator.

16. The system as defined in claim 13 wherein the primary and secondary mirrors of the subsystem have a ratio of depth to diameter of 1:4.

17. The system as defined in claim 13 further including a Kohler homogenizer component wherein radial symmetric mirror segments on both the primary and secondary mirrors are pair-wise correlated so that a segment on a primary images the field of view onto a secondary segment.

18. The system as defined in claim 17 wherein the Kohler homogenizer provides homogenization in both the radial and saggital directions so that the mirror segments in both primary and secondary are disposed in either a rectangular or hexagonal pattern.

19. The system as defined in claim 17 wherein the secondary mirror is co-planar with an entrance aperture and an exit aperture is co-planar with a vertex of the primary mirror.
